(19) United States
(12) Patent Application Publication
(10) Pub. No.: US 2017/0217103 A1
(43) Pub. Date: Aug. 3, 2017

(54) TECHNIQUES FOR COLOR CONTONING IN ADDITIVE FABRICATION AND RELATED SYSTEMS AND METHODS

(71) Applicants: Massachusetts Institute of Technology, Cambridge, MA (US); Universität des Saarlandes, Saarbrücken (DE)

(72) Inventors: Vahid Babaei, Cambridge, MA (US); Kiril Vidimce, Cambridge, MA (US); Piotr Didyk, Swiebodzice (PL); Wojciech Matusik, Lexington, MA (US)

(73) Assignees: Massachusetts Institute of Technology, Cambridge, MA (US); Universität des Saarlandes, Saarbrücken (DE)

(21) Appl. No.: 15/418,551

(22) Filed: Jan. 27, 2017

Related U.S. Application Data
(60) Provisional application No. 62/288,744, filed on Jan. 29, 2016.

(51) Int. Cl. B29C 67/00; B33Y 30/00; B33Y 10/00; B33Y 50/02; G05B 19/042

(52) U.S. Cl. CPC B29C 67/0088; B33Y 50/02; G05B 19/042; B29C 67/007; B29C 67/0092; B33Y 10/00; B33Y 30/00; G05B 2219/49023; B29K 2995/0021

(57) ABSTRACT

According to some aspects, a method is provided of producing multicolor objects via additive fabrication by forming a plurality of layers on a substrate from a plurality of materials each having a respective color, the method comprising obtaining image data, the image data indicating a color for each of a plurality of positions, determining a plurality of color stacks based on the image data, each color stack being determined based on the color associated with one of the plurality of positions of the image data, and each color stack specifying a sequence of materials, where each material in the sequence is selected from amongst the plurality of materials, and forming, via additive fabrication, a plurality of layers from the plurality of materials according to the specified sequence of materials associated with each color stack.

### CROSS-REFERENCE TO RELATED APPLICATIONS

The present application claims the benefit under 35 U.S.C. §119(e) of U.S. Provisional Patent Application No. 62/288,744, filed Jan. 29, 2016, titled “Continuous Color Printing with 3D Inkjet Printer,” which is hereby incorporated by reference in its entirety.

### BACKGROUND

Additive fabrication, e.g., 3-dimensional (3D) printing, provides techniques for fabricating objects, typically by causing portions of a building material to solidify and/or combine at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering, inkjet, polyjet, or combinations thereof. Many additive fabrication techniques build parts by forming successive layers, which are usually cross-sections of the desired object. Typically, each layer is formed such that it adheres to either a previously formed layer or a substrate upon which the object is built.

### SUMMARY

According to some aspects, a method is provided of producing multicolor objects via additive fabrication by forming a plurality of layers on a substrate from a plurality of materials each having a respective color, the method comprising obtaining image data, the image data indicating a color for each of a plurality of positions, determining a plurality of color stacks based on the image data, each color stack being determined based on the color associated with one of the plurality of positions of the image data, and each color stack specifying a sequence of materials, where each material in the sequence is selected from amongst the plurality of materials, and forming, via additive fabrication, a plurality of layers from the plurality of materials according to the specified sequence of materials associated with each color stack.

According to some embodiments, the image data represents a two-dimensional image and the plurality of color stacks are formed on a substantially flat substrate.

According to some embodiments, the method further comprises forming the substrate from a plurality of layers of a white material.

According to some embodiments, the method further comprises obtaining a model of a three-dimensional object having a surface, and the image data indicates a color for each of a plurality of positions on the surface.

According to some embodiments, the method further comprises forming a bulk region of the three-dimensional object from a substrate material, and at least portions of the plurality of layers formed from the plurality of materials according to the specified sequence of materials associated with each color stack are formed on the bulk region.

According to some embodiments, the method further comprises resampling a source image to produce the obtained image data.

According to some embodiments, the plurality of materials exhibit at least three different colors.

According to some embodiments, the at least three different colors include cyan, magenta and yellow.

According to some embodiments, each of the plurality of materials is a transparent material.

According to some embodiments, each of the plurality of materials comprises a photopolymer and one or more color pigments.

According to some embodiments, forming the plurality of color stacks via additive fabrication comprises depositing a liquid photopolymer and curing the photopolymer to a solid material.

According to some embodiments, each of the plurality of color stacks specifies a sequence of at least twenty instances of materials selected from amongst the plurality of materials.

According to some embodiments, the sequence of materials specified by each color stack groups instances of the same material in contiguous blocks.

According to some embodiments, the sequence of materials specified by each color stack includes instances of each material only in a prescribed order.

According to some aspects, an additive fabrication device configured to produce multicolor objects by forming a plurality of layers on a substrate from a plurality of materials each having a respective color is provided, the additive fabrication device comprising a build platform, one or more printheads configured to deposit liquid droplets of one of the plurality of materials onto the build platform or onto previously formed solid material, a source of actinic radiation configured to cure deposited liquid droplets to produce solid material, at least one processor, and at least one processor-readable medium comprising processor-executable instructions that, when executed, perform a method comprising obtaining image data, the image data indicating a color for each of a plurality of positions, determining a plurality of color stacks based on the image data, each color stack being determined based on the color associated with one of the plurality of positions of the image data, and each color stack specifying a sequence of materials, where each material in the sequence is selected from amongst the plurality of materials, and operating the one or more printheads to form a plurality of layers from the plurality of materials according to the specified sequence of materials associated with each color stack.

According to some embodiments, the image data represents a two-dimensional image and the plurality of color stacks are formed by the one or more printheads on a substantially flat substrate.

According to some embodiments, the method further comprises forming the substrate from a plurality of layers of a white material.

According to some embodiments, the method further comprises obtaining a model of a three-dimensional object having a surface, and the image data indicates a color for each of a plurality of positions on the surface.

According to some embodiments, the method further comprises forming a bulk region of the three-dimensional object from a substrate material, and at least portions of the plurality of layers formed from the plurality of materials according to the specified sequence of materials associated with each color stack are formed on the bulk region.

According to some embodiments, the plurality of materials exhibit at least three different colors.

According to some embodiments, the at least three different colors include cyan, magenta and yellow.

According to some embodiments, each of the plurality of materials is a transparent material.

According to some embodiments, each of the plurality of materials comprises a photopolymer and one or more color pigments.

According to some aspects, a method is provided of calibrating an additive fabrication device configured to fabricate multicolor objects by forming a plurality of layers on a substrate from a plurality of materials each having a respective color, the method comprising forming, using the additive fabrication device, a plurality of calibration patches having different colors, wherein each calibration patch is formed from a plurality of layers that are each formed from one of the plurality of materials, each calibration patch being associated with a layer specification, measuring an optical reflectance of each of the plurality of calibration patches at a plurality of different wavelengths of light, and determining a mapping between spectral absorption and the layer specifications of the calibration patches based at least in part on the measured optical reflectance of each of the plurality of calibration patches.

According to some embodiments, the method further comprises determining spectral absorption of each of the plurality of calibration patches at a plurality of different wavelengths of light based on the measured optical reflectances, and determining the mapping is based on the spectral absorption of each of the plurality of calibration patches.

According to some embodiments, forming the plurality of calibration patches comprises forming at least fifty calibration patches having different colors.

According to some embodiments, the plurality of materials exhibit at least three different colors.

According to some embodiments, the at least three different colors include cyan, magenta and yellow.

According to some embodiments, each of the plurality of materials is a transparent material.

According to some embodiments, each of the plurality of materials comprises a photopolymer and one or more color pigments.

According to some embodiments, each calibration patch is formed from at least twenty layers.

According to some embodiments, the method further comprises obtaining data indicative of a color and determining a sequence of the plurality of materials based on the color and the determined mapping.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1B illustrate one way to depict shades of gray from a single color using a halftoning technique;

FIG. 2 depicts additively fabricated materials formed on a substrate according to a contoning technique, according to some embodiments, and FIG. 2B is an inset illustrating a color order shown in FIG. 2;

FIG. 3 is a flowchart of a method for determining a color stack for color contoning via additive fabrication, according to some embodiments;

FIG. 4 illustrates a cross-section of a three-dimensional object to demonstrate an example of assigning base color materials to voxels, according to some embodiments;

FIG. 5A illustrates assignment conflicts at a geometric edge, according to some embodiments;

FIG. 5B illustrates assignment conflicts resulting from opposing surfaces, according to some embodiments;

FIG. 5C illustrates adjustment of the number of layers in the color stack to increase feature sharpness, according to some embodiments;

FIG. 6 is a flowchart of a method of determining color contoning calibration data, according to some embodiments;

FIG. 7 illustrates an additive fabrication device suitable for practicing some aspects of the present disclosure, according to some embodiments; and

FIG. 8 illustrates an example of a computing system environment on which aspects of the invention may be implemented.

### DETAILED DESCRIPTION

Additive fabrication devices generally fabricate objects from a single material, such as a plastic or other polymer, although some additive fabrication devices utilize multiple materials to vary the mechanical properties and/or the finished appearance of an object. In particular, some additive fabrication devices utilize materials of different colors to attempt to tailor the appearance of an object being fabricated. These devices use a halftoning approach to color reproduction, which is an analog of the approach used by conventional (“two-dimensional”) printers, such as laser printers.

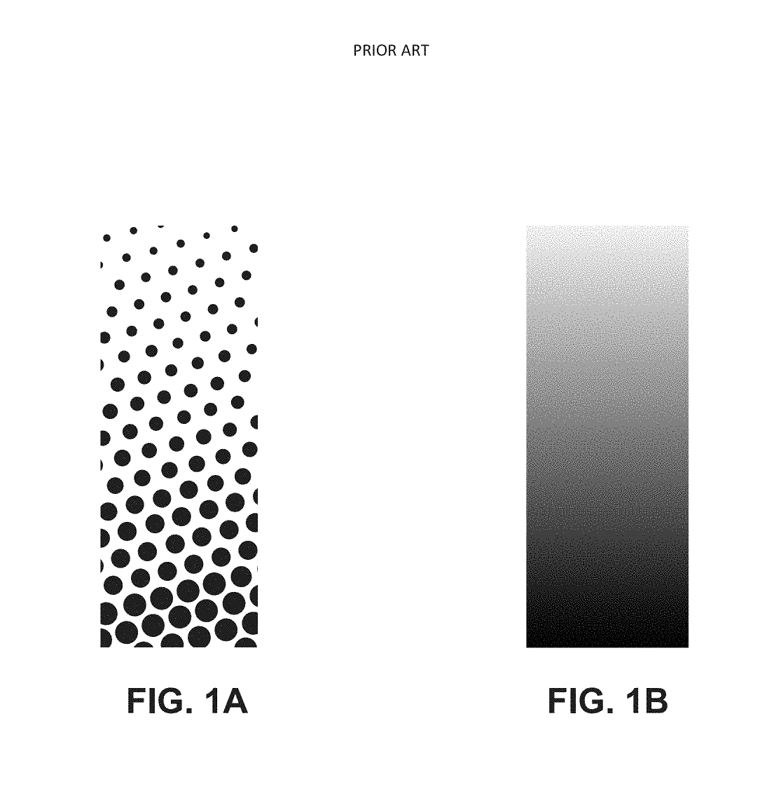

In halftoning, colors may be deposited onto a surface in various sizes and/or spacing that, when viewed from a sufficient distance, appear as a single color to the human eye. FIG. 1A illustrates an example of a halftone pattern that varies the sizes of dots of a single color. If the dots are sufficiently small, the pattern appears to be a smooth gradient when viewed from a distance by a human eye, as illustrated by FIG. 1B.

The use of halftoning in additive fabrication leads to several problems, however. Since halftoning relies on a pattern being viewed from a sufficient distance away that the colors are blended by the human eye, there is an effective minimum observation distance at which fabricated color objects can be viewed without the pattern being visible. In addition, the size of fabricated color regions must be larger than the smallest amount of color that can be deposited by the additive fabrication device, since halftoning works by spatially varying the amount of color over an area to produce a desired color. Thus, the effective spatial resolution (the effective smallest feature size) of the additive fabrication device is artificially lowered by the halftoning approach. Moire effects can also result from repeating halftone patterns and edge details can become blurry or otherwise indistinct in halftoning.

The inventors have recognized and appreciated techniques for reproducing colors in additive fabrication using “continuous tone” or “contone” techniques. These techniques create colors by overlaying different base colors on top of one another. If the base colors are suitably transparent, light can scatter through a collection of layers of different colors such that the layer together appear to be of a desired color. These stacks of layers may be formed on a substrate (e.g., a white surface) such that the layers effectively act like subtractive filters applied to light reflecting from the substrate. By producing suitably selected layers of base colors on the substrate, any desired color can hypothetically be produced. Unlike halftoning, the colors produced by contoning are continuous regardless of the viewing distance and can be produced at the spatial resolution of the additive fabrication device.

It can be a challenge, however, to accurately reproduce a desired color via contoning. For an additive fabrication device to be able to produce a desired range of colors (a “gamut”) from a relatively small number of base colors (e.g., 3-5) via contoning, more than a few layers of the base colors must be formed on top of one another. With even a relatively small number of layers, however, the color produced due to the behavior of light when propagating through the layers can be difficult or impossible to predict. Moreover, there are so many combinations of base colors that can be produced in just a few layers that it is not feasible to fabricate even a fraction of them to determine what colors will be produced for a given combination. For example, with one of 4 base colors deposited into each of 20 layers, there are over a trillion possible configurations.

The inventors have recognized and appreciated, however, that the appearance of a number of layers of different base colors depends largely on how many layers of each base color are present, and depends only marginally on the particular configuration. That is, for a given configuration of base colors in a stack of layers, a rearrangement of the same layers within the stack will produce a color that is largely indistinguishable from the color of the initial configuration. While the colors are in reality slightly different, the inventors have recognized and appreciated that there is no observable difference to the human eye.

This realization allows for much fewer allowable configurations of base colors in a color stack. One approach to reduce the number of configurations according to this realization is to adhere to a stratified layering scheme in which identical base colors are deposited adjacent to one another in the color stack and in which the base colors are sorted in a strict order. For instance, with base colors of cyan, magenta, yellow and black, the configurations considered may be only those in which all of the black layers are adjacent to one another and in which all of the black layers always appear below the other colors; those in which all of the yellow layers are adjacent to one another and in which all of the yellow layers always appear above the black layers and below the cyan and magenta layers; etc. Such a scheme dramatically reduces the number of possible configurations whilst retaining a desirable range of possible colors that can be produced. For example, with one of 4 base colors deposited into each of 20 layers using the above-described stratified layering scheme, there are only a few thousand possible configurations.

The inventors have further recognized and appreciated a calibration scheme for determining, for a given desired color, which configuration of base colors (i.e., which sequence of base colors should be arranged in a stack) will produce the desired color. Thus, accurate color reproduction may be performed. According to some embodiments, a mapping between a desired color to be fabricated and a corresponding layer specification may be produced by fabricating a number of calibration patches having different colors. The calibration patches can be preselected to have different layer configurations that together sample points across the space of colors that can potentially be produced from the base colors. The fabricated calibration patches may be analyzed (e.g., by observing their response to incident light) to determine how the preselected layer configurations appear once fabricated. This analysis can provide information on how the apparent (observed) colors map to the space of all possible layer configurations. A mapping of arbitrary apparent colors to the space of layer configurations can then be determined.

According to some embodiments, color stacks may be formed in a two-dimensional layout. For instance, to reproduce a two-dimensional image, the color stacks may be formed on a substantially flat substrate. The substrate may be formed prior to the formation of the color stacks. In this arrangement, an initial layer formed on the substrate can include the first base colors of each stack, a subsequent layer can include the second base colors of each stack, etc. Alternatively, the same object may be produced by forming the layers in a crosswise direction to the above-described approach, as discussed further below.

According to some embodiments, color stacks may be determined for a three-dimensional object in order to reproduce a desired color at points on the surface of the object. The color stacks may be formed so that they propagate inward along a direction normal to the associated point on the surface of the object. In some cases, however, due to the quantized nature of additive fabrication (i.e., that the device has limited spatial resolution along each axis), it may not be feasible to fabricate each color stack in the precise order and shape of the determined specifications. As such, some approximation may be performed based on the determined color stacks to determine how best to form the base colors to approximate the desired color stacks. Examples of such scenarios and illustrative approximations that may be performed are discussed below.

Following below are more detailed descriptions of various concepts related to, and embodiments of, techniques for additive fabrication of objects via color contoning. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

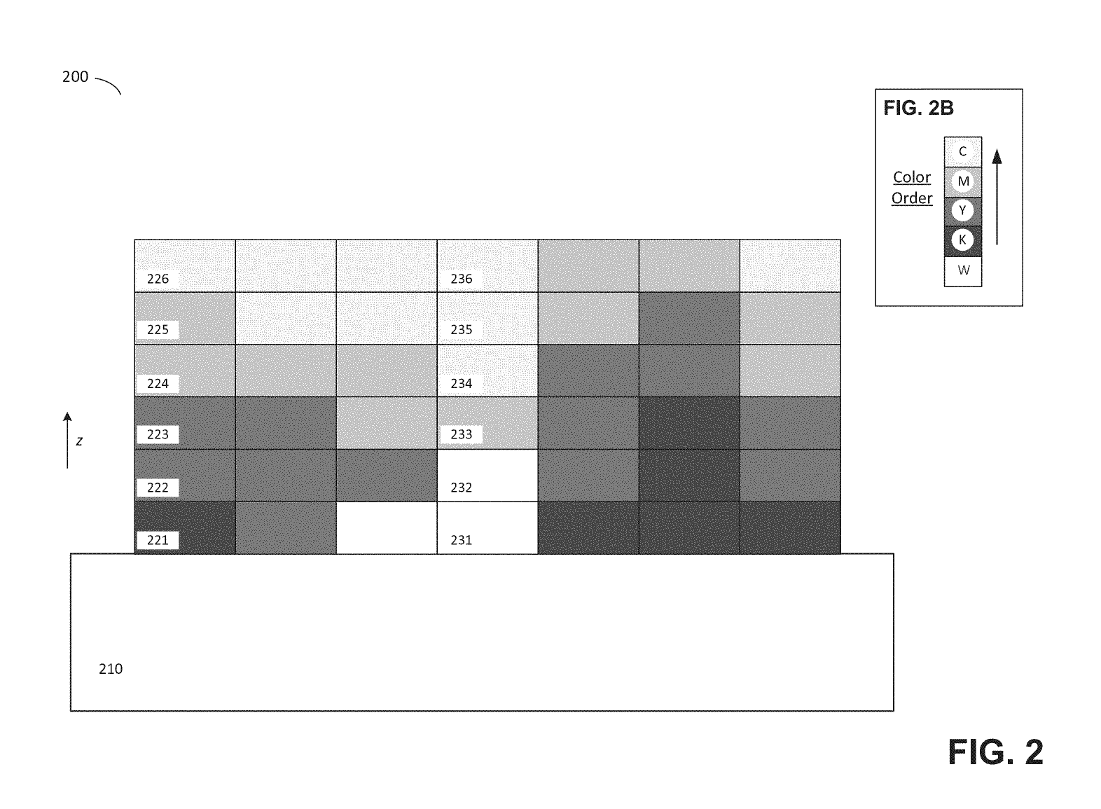

FIG. 2 depicts additively fabricated materials formed on a substrate according to a contoning technique, according to some embodiments. As discussed above, contoning comprises layering a number of base color materials on top of one another such that the combined base color materials appear as a desired color. For example, a layer of cyan over a white surface acts like a red filter, subtracting the red from white and leaving a mixture of green and blue light (which is cyan). Similarly, a layer of yellow over a white surface acts like a blue filter (leaving red and green) and a layer of magenta over a white surface acts like a green filter (leaving red and blue). As such, these layers may be combined to filter a desired amount of light at each point in the spectrum to produce a desired color. For instance, a layer of cyan and a layer of yellow over white will filter red and blue light to produce green light. If the layers are suitably thin and/or transparent, they will filter some, but not all, of the associated color of light; by combining several such layers a wide variation in colors can be produced from a combination of a small number of different base color materials.

In the example of FIG. 2, a number of color stacks have been fabricated on a substrate 210, of which the materials 221-226 is one example. The color stacks are formed from five different base color materials C, M, Y, K and W. These five colors are represented by different shades of gray in the figure and shown in the inset FIG. 2B. A “color stack” as used herein refers to a configuration of base color materials arranged to produce a desired color, and can include any number of base color materials selected from a group of available base color materials.

Typically, it is desirable that at least three different base colors are available so that wide range of colors can be produced, although in general an additive fabrication device may form objects from any number of base color materials. In the example of FIG. 2, five base color materials are available and have colors of: white (W), black (K), yellow (Y), magenta (M) and cyan (C). In general, any combination of base colors could be utilized so long as they can be combined to filter out desired portions of the visible spectrum of light. For instance, the base color materials could include base colors of red, blue and green in addition to, or as an alternative to, cyan, yellow and magenta.

In order to produce desired colors from base colors, the base color materials must act as filters for particular wavelengths of light but must let at least some light through at those wavelengths. For instance, a layer of cyan is a red filter, but if a cyan layer in a color stack were to filter out all red light, there would be many colors that could no longer be produced from the color stack because they those colors include at least some red light. As such, the layers of base color materials may be partial filters. It will be appreciated that the amount of absorption exhibited by a layer of base color material will depend on the physical structure of the layer (e.g., which materials are present, how much pigment, etc.) in addition to its size. The base color material layers fabricated in a color stack are referred to herein as being “transparent” although it will be appreciated that some light passing through such a layer will be scattered and some will be absorbed; nonetheless the layers may be substantially transparent to at least some wavelengths of light.

In some embodiments, a fabricated layer of base color material may filter between 10% and 50% of light of a characteristic wavelength passing through it, or between 20% and 40%, whilst filtering less than 20%, or less than 10%, of light of at least one other wavelength. For instance, a cyan material layer may, for a particular wavelength in the red part of the visible spectrum, filter between 10% and 50% of light having this wavelength. In practice, the filters may absorb light across a range of wavelengths. In some embodiments, layers of base color material may be configured to absorb light across the visible spectrum with Kubelka-Munk absorption coefficients varying between 0.1 and 0.3 (with the higher coefficients being present in parts of the spectrum that the base color material is designed to filter).

According to some embodiments, the base color materials may comprise one or more colorless, transparent materials in addition to one or more pigments. For instance, an additive fabrication device may be configured to form solid material by curing a liquid photopolymer, and the base color materials may each comprise a transparent, colorless liquid photopolymer combined with one or more color pigments. Concentrations of pigments may be determined during calibration of the additive fabrication device, a process for which is discussed below. In general, total pigment concentrations of a base color material comprising one or more colorless, transparent materials in addition to one or more pigments may be between 0.1% and 10% by weight, or between 1% and 5% by weight, or between 0.1% and 0.5% by weight, or between 0.1% and 0.3% by weight.

During additive fabrication, the base colors are deposited onto a substrate 210 and may be deposited within a number of three-dimensional volumes whose size in each direction is determined by the spatial resolution of the additive fabrication device along that direction. These volumes, or “voxels,” are depicted in cross section in FIG. 2 as shaded rectangles that have been formed on the substrate 210. In the example of FIG. 2, the vertical (z-axis) height of the voxels differs from their horizontal length, so they have a rectangular, not square, cross section. It will be appreciated that additive fabrication devices generally do not produce material in well-defined, cuboidal shapes as depicted in the figures herein, and that the depictions of voxels as having these shapes in the figures are provided for clarity. The techniques described herein are not limited to any particular shapes or sizes of deposited material in additive fabrication, and an object may be formed from any type of constituent voxels.

As discussed above, one technique to reduce the number of ways to combine the base color materials in a stack is to enforce a stratified layer structure in which identical base colors are deposited adjacent to one another in the color stack and in which the base color materials are sorted in a strict order. The example of FIG. 2 follows this approach by enforcing the color order shown in FIG. 2B (which is one example of a color order, and should not be considered as limiting). As described above, the inventors have recognized that such a scheme works because the appearance of a color stack largely depends upon the amount of each base color material present in the color stack, and only slightly depends on the order of the materials.

Illustrative color stack comprising materials 221-226, for example, illustrates this color order by including a layer of black material on the substrate (221), two layers of yellow material on the black material layer (222-223), two layers of magenta material on the yellow material layers (224-225) and a layer of cyan material on top (226). Since each of these material layers acts as a color filter, light reflecting from the white substrate 210 will be filtered by each of these layers and will emerge with some color that is generally different from any of that of the base color materials.

If it is desired that a color stack is white, then all of the layers in the stack can simply be formed from the white color. Similarly, very light colors may be formed from white with some layers of the other base colors on top. The color stack comprising materials 231-236 is an example of this type of color stack, which includes white material (231-232) in addition to some magenta material (233) and cyan material (234-236). This color stack will appear as a light blue color. An alternative way to describe this approach might be to consider the size of the color stack to be variable in the number of layers and to deposit substrate material at different heights based on the anticipated size of the color stack to be deposited on top at each position. However, this description is based on an assumption that the substrate material and the white base color material are both fabricated, and from the same material. Neither of these may necessarily be true, but in embodiments in which the substrate is a white material that is fabricated along with white layers in one or more color stacks, this approach may be employed.

In the example of FIG. 2, there are seven layers of base color materials in each color stack. In general, however, color stacks may be formed from any number of base color material layers. The number of layers in a color stack determines the range of possible colors that can be produced (the gamut) and the density of possible colors that can be selected from within the range. The more layers, the more combinations of base colors can be realized and the more colors can potentially be produced. However, due to light diffusing through the stack of materials, the sharpness of color features also decreases as the number of layers increases. Light diffusing through the materials will generally be deflected the most at interfaces between the materials, such that the more layers are deposited, the greater the light will be diffused. Thus, more layers tend to spread out the appearance of features. This phenomenon is known in the two-dimensional printing field as optical dot gain. Given these advantages and disadvantages of producing more color layers, the inventors have recognized that around 20-80 layers in a color stack gives a good tradeoff between the above-described phenomenon. In some embodiments, the color stacks may be formed from between 10-50 base color material layers, or between 40-80 base color material layers, or between 45 and 65 base color material layers, or may be formed from 48 base color material layers or 60 base color material layers.

The techniques for color contoning via additive fabrication described herein are equally applicable to two-dimensional and three-dimensional objects. The example of FIG. 2 is one in which a two-dimensional image may be reproduced on a substantially flat substrate. As such, the structure shown in FIG. 2 may be fabricated without any three-dimensional object model being provided as input. Rather, the voxels to be fabricated and the base materials to form in each voxel can be determined based on the determined color stacks for each color in the image (e.g., a color stack for each image pixel). Techniques for fabrication of color three-dimensional objects is discussed further below.

According to some embodiments, the substrate 210 may be formed via additive fabrication. For instance, the substrate 210 may be formed from one of the base colors. In the example of FIG. 2, for instance, the substrate may be formed from the same white material used to form voxel 231 (among others). Where the substrate is formed from a base color material, the substrate may be formed from a number of layers sufficient to produce an opaque substrate so that light does not substantially pass through the substrate but is reflected by it, thereby maximizing the amount of light reflected through the color stack. According to some embodiments, the substrate 210 may be a material formed through some technique other than additive fabrication and the color stacks may be formed on its surface.

In the example of FIG. 2, the voxels have been described as having been fabricated in the z-direction pictured. There is no requirement that the voxels shown be fabricated in this fashion, however. For instance, the depicted structure could be fabricated at right angles to that shown, such that each given color stack is formed at the same z-height. It has been found by the inventors that such approaches to fabrication yield approximately the same quality of color reproduction. Accordingly, it will be appreciated that the techniques described and/or pictured herein are not intended to limit the described and/or pictured structures to being fabricated in the orientation described and/or pictured.

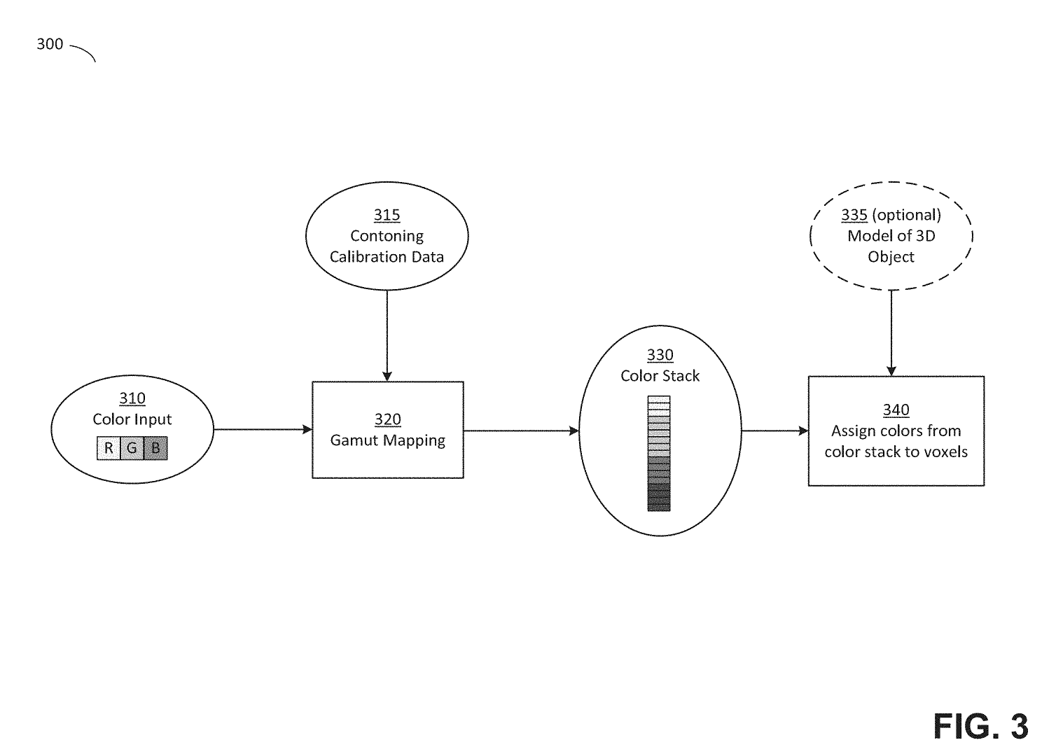

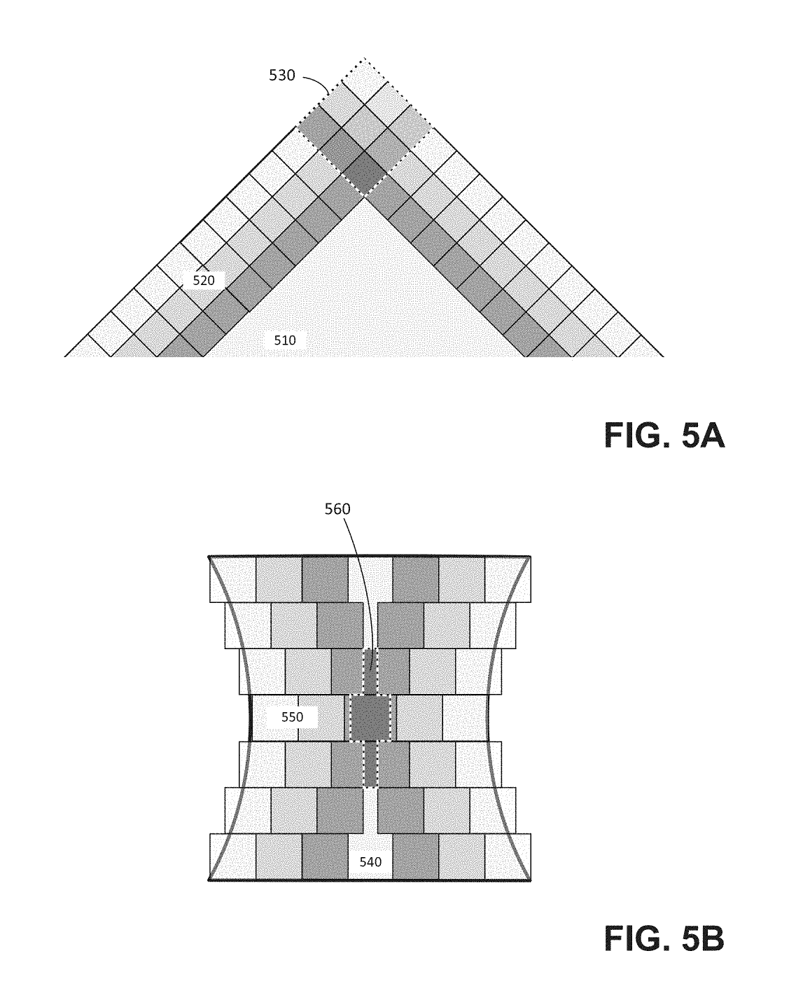

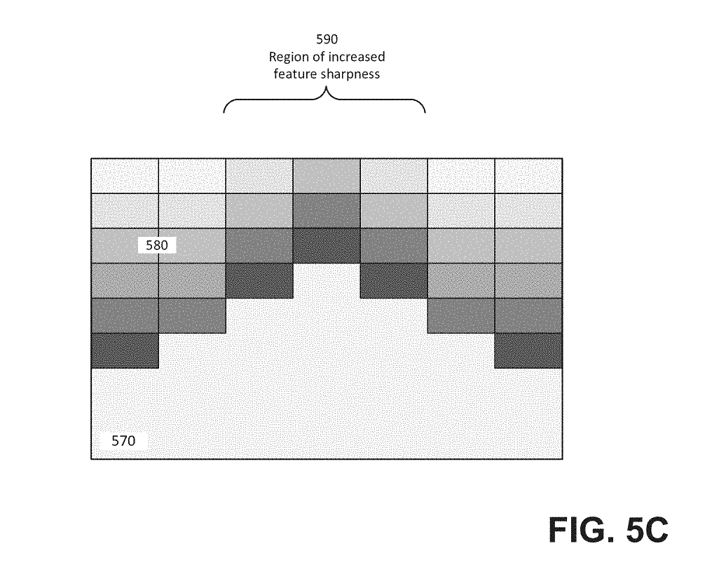

FIG. 3 is a flowchart of a method for determining a color stack for color contoning via additive fabrication, according to some embodiments. In order to reproduce a desired color, a system must be developed for determining a color stack (again, being a configuration of base color materials) that, once fabricated, will produce that color to a close approximation. The process of determining how to map a desired color to a color stack is referred to herein as a calibration process. This calibration process will generally depend on multiple characteristics of the additive fabrication device being used, such as the additive fabrication technique, the available fabrication materials, the resolution of the device, etc. The flowchart of FIG. 3 illustrates how the data determined during calibration may be utilized when preparing to fabricate an object. Techniques for determination of the calibration data itself is discussed below in relation to FIG. 5.

Method 300 shown in FIG. 3 may be performed to determine how to fabricate two-dimensional objects (e.g., reproduction of a two-dimensional image on a flat surface) or three-dimensional objects (e.g., fabricating a three-dimensional object with color on the surface defined by image data). The method 300 shown in FIG. 3 illustrates, for purposes of clarity, the process by which a color stack is determined from a single color input value according to predetermined calibration data. Method 300 can be performed a number of times in order to determine all of the color stacks for a given object to be fabricated.

In act 310, a color value is provided as an input. The color value can be represented in any suitable way, such as an RGB, HSV, HSL, etc. Method 300 may be arranged to expect colors from a certain color space as input; since the calibration data maps an input color to a target color stack, the calibration data may be configured based on upon an particular color space of the input color 310. In some embodiments, calibration data may be defined for multiple input color values and appropriate calibration data 315 selected according to the color space of the input color 310. In some embodiments, color input 310 is a color defined in the sRGB color space.

According to some embodiments, color input 310 may represent the color of a pixel in a two-dimensional image. When producing a two-dimensional image using the color contoning process described herein, the process may take as an input an image file that is arranged with a number of pixels along each axis that is equal to the size to be fabricated divided by the size of voxels that are to be fabricated along that axis. That is, the image may be arranged such that a single color stack can be fabricated for each pixel and an object of the desired size will be produced. In some embodiments, if an image is not sized as described above, it may be resampled as an initial step to produce an image of that size.

In some embodiments, an input image may be a compressed image, such as a JPEG or PNG image file. Such image files may store values that must be decompressed in order to determine color values for each pixel. In some embodiments, method 300 may be further configured to determine color input values for each pixel based on the compressed image data by decompressing the data and identifying the color values for each pixel from the decompressed data.

Irrespective of how the color input 310 is provided, in act 320, the color input 310 is mapped to a color stack 330 via a gamut mapping process, based on calibration data 315. As discussed above, since the calibration data maps an input color to a target color stack, the calibration data may be configured based on upon a particular color space. The gamut mapping operation in act 320 may accordingly perform a gamut mapping within that color space.

In some embodiments, act 320 includes a conversion from the color space of the input color 310 to a target color space (e.g., the color space of the color stacks or some other color space) prior to gamut mapping. For example, the gamut mapping may be performed in a device-independent color space, such as CIELAB. In this example, act 320 may convert input color 310 into the CIELAB color space should it not already be defined according to that color space.

In act 320, once any color space conversions have been completed, the gamut mapping from the color input to the color stack may be performed using any suitable technique. In some embodiments, the gamut mapping may be performed as follows: initially, the lightness range of the input color space gamut (e.g., sRGB gamut) may be mapped into the lightness range of the color stack gamut. Then, the lightness-mapped gamut can be chroma mapped into the gamut of the color stacks for each hue-angle slice.

Calibration data 315 can be configured in numerous ways to facilitate the gamut mapping process of act 320. In some embodiments, calibration data 315 may provide one or more algorithms and coefficient values associated with those algorithms for converting between color spaces and/or for performing gamut mapping operations.

In some embodiments, calibration data 315 may include one or more lookup tables in which the results of color space conversions and/or gamut mapping operations have been precomputed. For instance, calibration data 315 may include a lookup table in which an sRGB value can be looked up to obtain a color stack 330. In other words, any color space conversions and/or gamut mapping operations may be “baked into” the lookup table data. This approach may lower the computational overhead of determining a color stack for a given an input color at the cost of increasing the amount of data necessary for such a determination.

In some embodiments, gamut mapping 320 may comprise a nearest neighbor search within a color space. The gamut of the color stacks may be described by a set of discrete points in a three-dimensional color space (e.g., CIELAB), where each of these points corresponds to a particular color stack configuration. When the color input 310 is mapped to this space by the gamut mapping operation, the determined position in the color space may not correspond to one of the discrete points. As such, a nearest neighbor search may be performed to determine the nearest one of the discrete points to the point in the color space determined by gamut mapping. The color stack with the identified nearest neighbor is then selected for the contoning process. In some embodiments, the nearest neighbor search includes a KD-tree nearest neighbor search.

Once a color stack 330 has been determined according to the gamut mapping operation in act 320, in act 340 the color stack is used to assign colors to voxels of an object to be fabricated. For a two-dimensional picture, the color stacks can simply be used to fill voxels at the surface of the object with a substrate being formed or provided underneath these voxels (as in the example of FIG. 2).

According to some embodiments, for a three-dimensional object a model of the object may be provided as input 335. How to fill voxels of the object in three dimensions may be determined such that the color stacks can best approximate the color input associated with respective points on the surface of the object when viewed normal to the surface at those points. The remainder of the three-dimensional object other than these voxels filled based on the color stacks may be filled with any suitable materials. Since the exterior portion of the three-dimensional object defines the optical appearance of the object via the fabricated color stacks, any number of materials having, for instance, different mechanical properties from the base color materials may be formed within the remainder of the object. For example, a core region of a fabricated three-dimensional object could be fabricated from a comparatively flexible material, whereas the base color materials formed at the surface of the object could be fabricated from a comparatively rigid material.

Irrespective of whether a two-dimensional picture or three-dimensional object is to be fabricated, each color input may be associated with a position within the picture or position on the surface of the object, and this position may inform which voxels are determine to be filled and by which base color materials in act 340. In the case of a two-dimensional picture, these positions may be provided implicitly by an input image from which the color input values are extracted. That is, the position of a pixel in the image may dictate where a color stack corresponding to the color of that pixel will be fabricated.

In the case of a three-dimensional object, information on how to map image data onto the three-dimensional object 335 may be provided in order that a point on the surface of the object can be identified for each color in the image data. In some embodiments, how to map image data onto the three-dimensional object may be provided as data separate from the image data, such as in a UV map.

According to some embodiments, base color materials may be assigned to voxels of a three-dimensional object in the following manner. A model of a three-dimensional object may be discretized (e.g., voxelized); for instance, a 3d mesh may be discretized to determine voxels of the object. For voxels at or near the surface of the discretized object, a base color material may be mapped to that voxel based on image data and texture coordinates (e.g., UV map) associated with the image data. Thus, the texture coordinates and image data inform which color is to be produced at various points on the surface of the object. Once a color stack has been determined for that color via the above-described process, voxels can be assigned base color materials according to that color stack as follows. For voxels in the object, a distance from the voxel to the nearest point on the surface of the object is calculated. Then, a virtual layer index into the associated color stack is determined along the normal vector for that surface point, and the base color material at this index is assigned to the voxel. For example, if the voxel is 100 microns from the surface and each layer in the color stack is assigned a 10 micron thickness, that voxel will be assigned the 10th base color material from the top of the color stack.

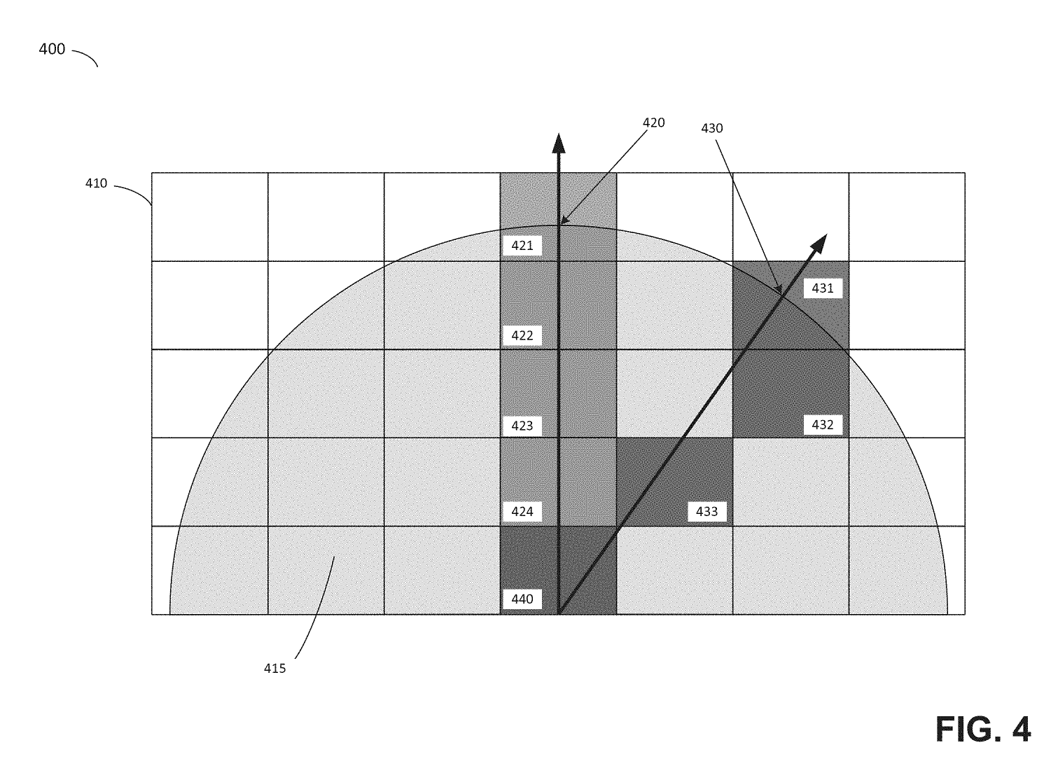

As will be discussed further below, there are numerous challenges to assigning base color materials to voxels in a three-dimensional object based on color stacks determined for points on the surface of the object. One initial challenge is that the size and orientation of a color stack propagating into the object along a direction normal to the surface of the object will generally not allow a one-to-one mapping between base color materials defined by the color stack and voxels along the path in the normal direction. Another challenge is that, since the color stacks protrude into the surface of a three-dimensional object, these color stacks can collide with one another for certain geometries (e.g., convex shapes), which can lead to assignment conflicts. These two challenges are illustrated by FIG. 4, which depicts a cross-section of a three-dimensional object, according to some embodiments.

In the example of FIG. 4, a portion of a three-dimensional object to be fabricated 415 is depicted, with the illustrated portion having a half circle cross-section. Overlaying this object in the figure is a grid 410 illustrating voxels in which an additive fabrication device can form base color materials. In order to fabricate this object in color via the color contoning techniques described herein, image data for positions on the surface of the object are first obtained, as discussed above. For each color value in the image data, a color stack is determined for the associated position on the surface of the object, as discussed in relation to FIG. 3. Then, the base color materials to be fabricated, if any, are determined for the voxels of grid 410.

In the example of FIG. 4, two illustrative positions 420 and 430 are contemplated on the surface of object 415. A color stack may be determined for each of these positions according to a color associated with the respective position. In the example of FIG. 4, the color stack determined for position 420 informs how to fill the voxels 421, 422, 423, 424 and 440. In this example, the color stacks have a depth of five base material layers for simplicity of explanation. Base color materials for the voxels 421, 422, 423, 424 and 440 may be selected according to this determined color stack, though are illustrated in the figure with a uniform shade for clarity.

Determining base color materials for position 430 is less straightforward than for position 420, however. As shown in FIG. 4, unlike the normal vector for position 420, the normal vector for position 430 does not pass through the center of a sequence of voxels. As such, the color stack determined for position 430 must be approximated because a line of five voxels cannot be filled with the five base color materials of the color stack as was the case with position 420. Instead, four voxels 431, 432, 433 and 440 are selected to approximate this color stack, and base color materials for these four voxels determined to best approximate the five base color materials of the color stack.

Furthermore, note that voxel 440 has been assigned base color materials by color stacks associated with each of the positions 420 and 430, thereby producing an assignment conflict if the assigned base color materials are different. There are numerous strategies to handle assignment conflicts, of which two examples are described below. Initially, however, it is noted that using the contoning approach described herein, assignment conflicts generally occur several voxels into the surface of a three-dimensional object, which makes any errors resulting from resolving an assignment conflict less visible than if they were to appear close to the surface. Moreover, a stratified layout structure in which identical base colors are deposited adjacent to one another in the color stack and in which the base colors are sorted in a strict order will result in fewer assignment conflicts than unordered color stack structures, because with the stratified layout it is more likely that the same base color material will be assigned to the same voxel for two different surface positions.

According to some embodiments, assignment conflicts may be resolved by determining which of the positions on the surface that gave rise to the conflict is the closest to the conflicted voxel. Since base color materials formed closer to the surface may be more visible, this approach to resolving the conflict may reduce the chance that the choice of base color material will negatively affect other positions. In the example of FIG. 4, this approach to resolving the conflict will not produce a helpful solution because voxel 440 is essentially equidistant from positions 420 and 430.

According to some embodiments, assignment conflicts may be resolved by averaging colors associated with positions on the surface before assigning base color materials to voxels. This approach resolves conflicts by reducing the chances of them occurring. When the colors are averaged at the surface, the color stacks determined for these colors may be more similar than they were prior to averaging. Thus, there is a lower chance of an assignment conflict. In practice, the possibility of assignment collisions may be identified by examining the geometry of a three-dimensional object prior to determining color stacks for the object. Image data may be averaged in discrete locations based on identified positions on the object where there is a comparatively high risk of assignment error (e.g., pixel values may be averaged with their neighbors to smooth out the variation in color values). This image data may then be provided as input to determine color stacks and base color materials for voxels in the usual manner described above.

To further illustrate scenarios in which assignment conflicts can arise, FIG. 5A illustrates color assignment conflicts at a geometric edge, according to some embodiments. In the example of FIG. 5A, color stacks of three layers 520 are to be formed adjacent to a substrate 510. However, layer conflicts can result at the apex of the structure (region 530). Note that this is true irrespective of in which direction the illustrated structure is fabricated. When conflicts occur, the above-described techniques may be applied. In this case, averaging the colors on the surface may be a more desirable solution since the distance to the surface is essentially the same at each conflicting point in region 530.

FIG. 5B illustrates color assignment conflicts arising from opposing surfaces, according to some embodiments. In the example of FIG. 5B, color stacks of three layers 550 are to be formed adjacent to a substrate 540. However, due to a thin region at the center of the pictured object, color stacks from opposing sides can conflict in the central region 560. In some cases, the colors on opposing sides may be the same or similar colors. In this case, either no conflict may result, or resolving the conflict by picking one base color material over another may not produce a noticeable difference because the conflicting position is located deep inside the structure and because the colors are similar.

On the other hand, when the opposing sides are displaying very different colors, such a resolution may be less desirable because either choice of base color material may negatively impact one side or the other. Averaging the colors as described above may also be undesirable because there may be a significant distance across the surface from one side to the another, and averaging colors over such a distance may negatively affect the range of colors over that area. In this case, one approach to resolving the conflict is to reduce the size of color sacks in regions where the conflicts would otherwise occur (i.e., region 560). As discussed above, a color stack with comparatively fewer layers has a comparatively smaller color gamut available, but this may be a preferable solution in the situation in FIG. 5B. That is, by reducing the color stack size around region 560, the color stacks may not overlap and cause conflicts, but as a result the colors produced from these color stacks may be less accurate reproductions than would otherwise have been produced because there are fewer layers available from which to produce the color.

FIG. 5C illustrates adjustment of the number of layers in the color stack to increase feature sharpness, according to some embodiments. FIG. 5C is an example of reducing the stack size not to avoid conflicts, as above, but to increase feature sharpness. As discussed above, optical dot gain grows as the number of layer in the color stack increases. If it is desirable to sharpen small features and/or edges, the voxels can be arranged to fabricate additional substrate material and a shorter color stack to get more sharpness at the cost of less accurate color reproduction.

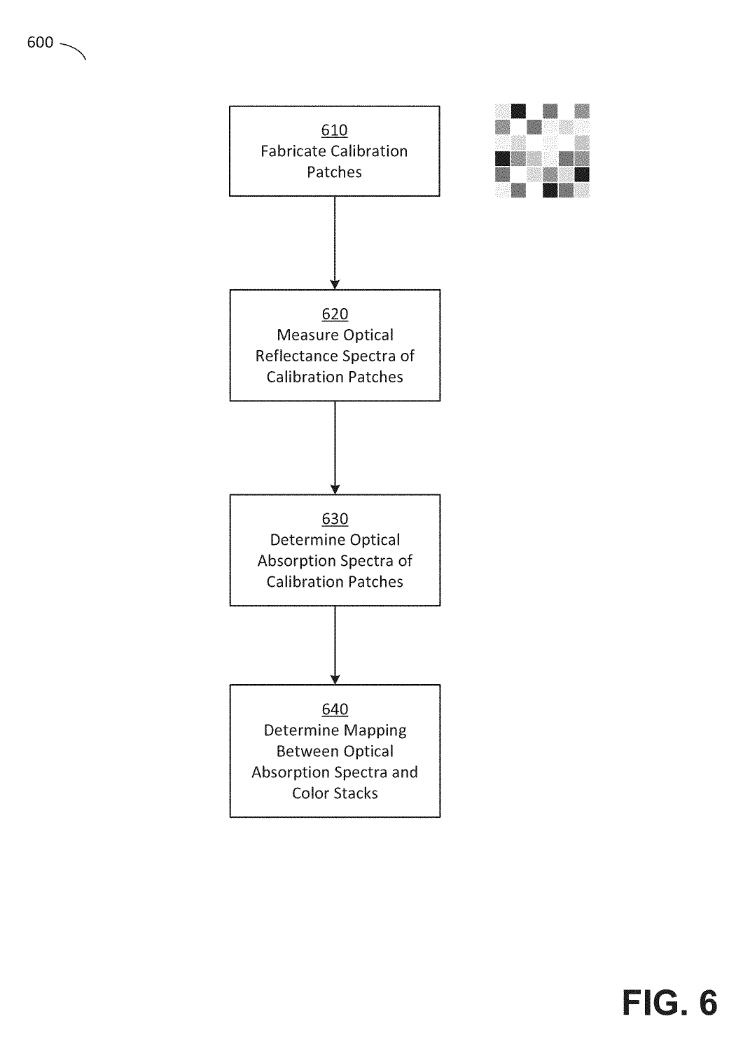

FIG. 6 is a flowchart of a method of determining color contoning calibration data, according to some embodiments. As discussed above, the color produced due to the behavior of light when propagating through a color stack can be difficult or impossible to predict. As such, to accurately reproduce colors via color contoning, a model of how fabricated layer stacks appear is developed. Due to the large number of possible color stack configurations, however, to understand how each color stack will look would require a huge amount of fabrication for calibration. This is true even under the stratified layout, which for four base color materials and twenty layers still has over 10,000 configurations.

The inventors have recognized techniques, however, for producing a model of the color space of the color stacks by fabricating and measuring a manageable number of calibration patches. The colors of these patches may be selected to evenly and broadly sample the color space (e.g., ink space) of the color stacks. Method 600 begins in act 610 in which a number of these calibration patches are fabricated.

According to some embodiments, color stacks for the calibration patches may be selected by selecting only color stacks for which the number of layers of each base color material is a multiple of some selected number. For example, color stacks of 20 layers may be fabricated for which the number of base material layers fabricated is 0, 5, 10, 15 or 20. Selecting the base color materials for such color stacks is thus equivalent to selecting base color materials for only four layers (four multiples of 5). For four materials, the number of configurations with this restriction (in addition to the stratified layout restriction) is 70, which is a manageable number of patches to fabricate. These 70 calibration patches also evenly sample the color space of the color stacks.

Irrespective of how many calibration patches are fabricated in act 610, in act 620 the optical reflectance spectrum of each patch is measured. In order to understand how the different color stacks of the calibration patches give rise to different visible colors, the optical absorption of each color stack is determined at a plurality of wavelengths. This property may not, however, be directly measurable in practice, and so instead the optical reflectance is measured, which can be used to calculate the optical absorption. In act 620, the optical reflectance of each calibration patch is measured at a plurality of wavelengths to characterize how the patch reflects different colors of light.

According to some embodiments, optical reflectance is measured in act 620 by a spectrophotometer. This device provides a diffuse incident illumination through an integrating sphere. The diffuse incident light falls on a calibration patch at all possible angles and a sensor captures the reflected light. Irrespective of what type of device is used to measure the optical reflectance in act 620, the optical reflectance may be measured for each calibration patch at a number of different wavelengths in the visible spectrum.

In act 630, the optical absorption spectrum for each calibration patch is determined based on the measured optical reflectance. This conversion is desirable because there is no linear relationship between optical reflectance and the color stack arrangements. Such a relationship does exist between optical absorption and the color stack arrangements, however, making feasible a determination of a mapping between the two.

In act 640, a mapping is determined between the optical absorption spectra determined in act 630 and the respective color stacks to which each spectra corresponds. A detailed example of how to determine this mapping is described below, but in general such a mapping may be determined by performing a linear regression in the intrinsic absorption space. This regression provides a relationship between the absorption spectrum and any given color stack.

According to some embodiments, the mapping may be determined in act 640 in the following illustrative manner. A common practice in color modeling is to find a space where there is a linear relationship between the concentrations of primary materials and the resulting color of their mixture. This is a basis for the use of Kubelka-Munk (KM) equations in computational color science. The KM scattering and absorption coefficients are expected to scale linearly with the concentrations of coloring agents. When optical absorption is a more significant event occurring within the fabricated base color materials than scattering, it is possible to use a simplified version of the KM theory which is based on absorption coefficients, and to build the regression based on absorption.

In the absence of scattering, the absorption of a based material layer ψ(λ) printed on a diffusing substrate with reflectance spectrum R_{g}(λ) has the following relationship with the reflectance spectrum R(λ) of a stack of base color materials on a substrate:

R(λ)=R_{g}(λ)exp(−2ψ(λ)). (Eqn. 1)

All above quantities are functions of the wavelength λ. Where the base color materials do not show fluorescence, all wavelengths can be treated independently and the computations can be performed wavelength-by-wavelength. The KM theory assumes no discontinuity in the refractive index (neglecting the obvious air-base color material interface). Therefore, we first apply a Saunderson correction on the measured spectral reflectance to obtain the intrinsic reflectance. The intrinsic reflectance is the reflectance of a surface if there were no air-surface interface. We can then calculate the intrinsic absorption coefficient ψₛ(λ) of a print using Equation 1 as:

$${ψ}_{s} ( λ ) = - \frac{1}{2} ln ( \frac{ρ ( λ )}{{ρ}_{g} ( λ )} ) , \qquad ( Eqn . 2 )$$

where ρ(λ) and ρ_{g}(λ) are the intrinsic reflectances of the sample R(λ) and the substrate R_{g}(λ), respectively.

According to the classic KM equations, the spectral absorption of every fabricated color stack can be computed through convex combination of the spectral absorptions of its components. This gives large errors because of inaccuracies in KM theory assumptions, errors in fabrication and measurement processes, and the stray specular light captured during measurement. A compromise is to build a multilinear regression in the absorption space based on a small training dataset. The following relationship is built by concatenating the intrinsic absorption coefficients ψₛ(λ) of the prints belonging to the training dataset in matrix Ψₛ and their corresponding layer-layout in matrix C.

Ψₛ=TC. (Eqn. 3)

Having solved for matrix T, this matrix maps any fabricated color stack with a known layer-layout (thicknesses of different base color materials in matrix C) to its intrinsic absorption coefficient ψₛ(λ). From the intrinsic absorption coefficient, we can use Equation 2 to obtain intrinsic reflectance ρ(λ). Finally, we can add back the effect of discontinuity in refractive index to the intrinsic reflectance using an inverse Saunderson correction to obtain a predicted reflectance that is comparable to measured reflectances Conceptually, matrix T contains the spectral absorptance bases for all base color materials at all wavelengths. Its size is therefore the number of wavelengths times the number of materials. The training set is a set of spectral measurements of prints in which thicknesses of different base color materials are uniformly sampled from 0 to L layers, with a fixed interval, where L is the maximum thickness.

One limitation of this approach is that matrix T is identical for all calibration patches with different color stack configurations. To address this limitation, we use a weighted regression where a distinct parameter matrix is tailored for every calibration patch. In the regression, we give higher weights to training samples with more similarity to a given calibration patch. As a similarity metric, we use the inverse of the distance between the color stack configuration of the i-th calibration patch cᵢ and that of the j-th training color stack cⱼ.

$${s}_{ij} = \frac{1}{{‖ {c}_{i} - {c}_{j} ‖}_{2}} . \qquad ( Eqn . 4 )$$

For p calibration patches to be predicted using q training color stacks, we compute a p×q similarity matrix S with entries sᵢⱼ:

$$S = [ \begin{matrix}{s}_{11} & {s}_{12} & {s}_{13} & … & {s}_{1 q} \\ {s}_{21} & {s}_{22} & {s}_{23} & … & {s}_{2 q} \\ ⋮ & ⋮ & ⋮ & ⋮ & ⋮ \\ {s}_{p 1} & {s}_{p 2} & {s}_{p 3} & … & {s}_{pq}\end{matrix} ] . \qquad ( Eqn . 5 )$$

We can then rewrite Equation 3 as a weighted multilinear regression for each calibration patch separately:

ΨₛW=TCW. (Eqn. 6)

For the i-th calibration patch, matrix W is a q×q diagonal matrix whose diagonal elements are the i-th row of S. In order to obtain the parameter matrix, we need to perform the following optimization:

$${argmin}_{T} {‖ {Ψ}_{s} W - TCW ‖}_{2} . \qquad ( Eqn . 7 )$$

We need to solve this minimization to predict the spectrum of every calibration patch. Fortunately, the least square solution to this equation is the pseudo-inverse solution that can be computed efficiently as:

T=ΨₛW²C(CW²C^{t})⁻¹ (Eqn. 8)

Matrix T can then be used, as explained above, to calculate the spectral reflectance of its corresponding color stack. As the resulting gamut of color stacks is a set of discrete colors, a nearest neighbor search may be performed in the color space of the color stacks to identify the best match for a given absorption spectrum.

According to some embodiments, an inverse mapping can be determined that, for a given color stack, produces an associated color that would be produced if the stack were fabricated. This mapping may be used to generate previews of an object to be fabricated, so that once voxels of an object are assigned base color materials, a software process can generate a three-dimensional image of what the object would look like once fabricated.

Interrelated to the process of determining the mapping in act 640 is a process of optimizing an amount of pigment in each of the base color materials. The number of layers to be fabricated in each color stacks informs the pigment concentrations, because the pigment concentration should maximize the amount of light that is reflected from the substrate rather than filtered.

According to some embodiments, pigment concentrations may be optimized by selecting an initial concentration for each base color material and performing method 600 to determine the mapping between the calibration patches fabricated using the initial concentrations and their absorption spectra. An error metric may then be calculated by gamut mapping input colors to the color stacks (as in FIG. 3) and calculating the color error difference between the candidate color stacks and their nearest neighbors. If the error metric is above a desired threshold, the pigment concentrations can be adjusted (e.g., halved) and the above procedure repeated to fabricate new calibration patches, determine a new error metric, etc. until the error metric has reached a desirable level.

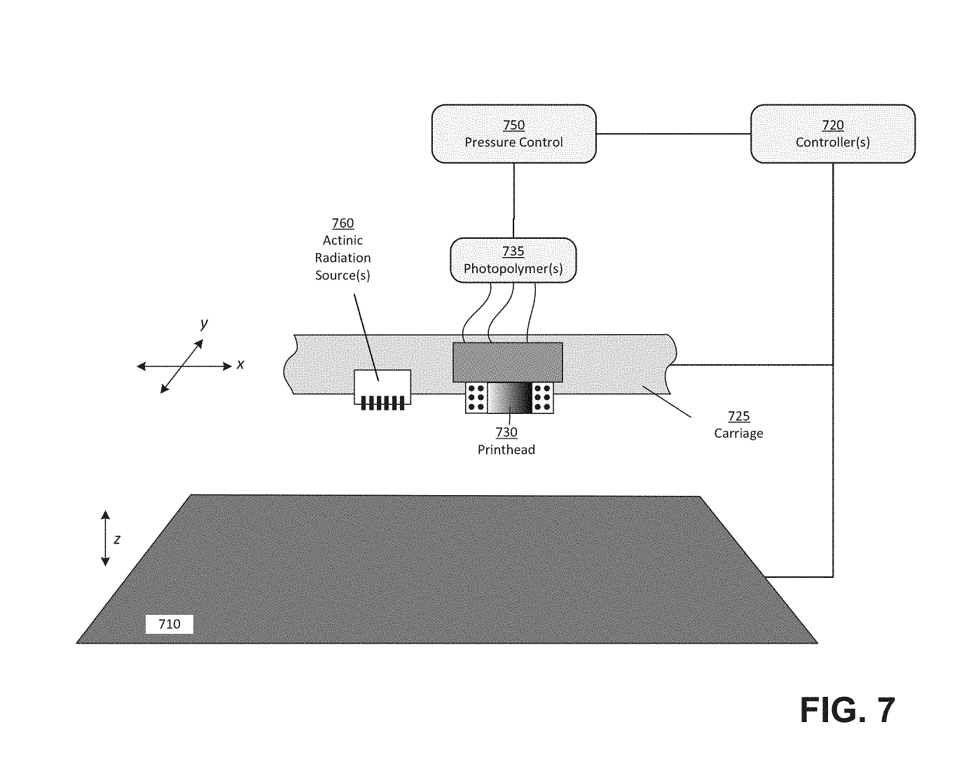

FIG. 7 illustrates an additive fabrication device suitable for practicing some aspects of the present disclosure, according to some embodiments. Illustrative additive fabrication device 700 is configured to produce solid materials via inkjet printing, in which a liquid photopolymer is deposited onto a surface and a source of actinic radiation (e.g., ultraviolet light) is directed onto the photopolymer causing it to cure into a solid.

In the example of FIG. 7, additive fabrication device 700 includes a build platform 710 upon which objects can be fabricated from a combination of one or more cured photopolymers. While the example of FIG. 7 presents an additive fabrication device that forms solid material using liquid photopolymers, it will be appreciated that the techniques described herein are applicable to solid materials formed using other additive fabrication techniques as well.

In the example of FIG. 7, additive fabrication device 700 includes, or is coupled to, one or more controllers 720 which control motion of the build platform 710, and by moving the carriage 725, the motion of printhead 730 and actinic radiation source 760. In some embodiments, the controller(s) 720 may include one or more general purpose processors (including CPUs and/or microprocessors) programmed to perform any number of these control operations and/or may include one or more customized circuits (e.g., ASICs) configured to perform any number of these control operations. The controller may be configured to fabricate an object from one or more base color materials according to computer-readable instructions provided to the controller. These instructions may include instructions to move the carriage and build platform, to produce material from the printhead 730, turn off and turn on the actinic radiation source 760, etc. Each of the controller(s) 720 may be located within a common housing of the additive fabrication device as the other pictured elements in FIG. 7, or may be located in another device coupled to these elements (e.g., in a computer connected via a wireless and/or wired connection).

In the example of FIG. 7, the build platform 710 is configured to move along a vertically-aligned z-axis, whereas the carriage 725 is configured to move along x- and y-axes that are both perpendicular to the z-axis. Any number of motors or other such actuators may be arranged to move these elements along the pictured axes. It will be appreciated that the particular axes of motion of the build platform and carriage shown in FIG. 7 is provided merely as one illustrative example, and other configurations are possible so long as the components of the carriage (e.g., printhead) can be positioned at desired locations within a three dimensional build volume relative to the surface of the build platform.

In the example of FIG. 7, the controller(s) 720 operate pressure control module 750, which controls production of liquid photopolymer(s) 735 via printhead 730. According to some embodiments, printhead 730 may include multiple nozzles that may be actuated independently to produce liquid. In some embodiments, the additive fabrication device 700 may be configured to produce different liquids from different nozzles of the same printhead simultaneously. The photopolymer(s) 735 may include prepared base color materials having selected pigment concentrations optimized as discussed above. Production of liquid droplets from the printhead may be controlled by any suitable actuator. In some embodiments, the pressure control module 750 controls a piezoelectric actuator that controls production of liquid droplets at the printhead 730.

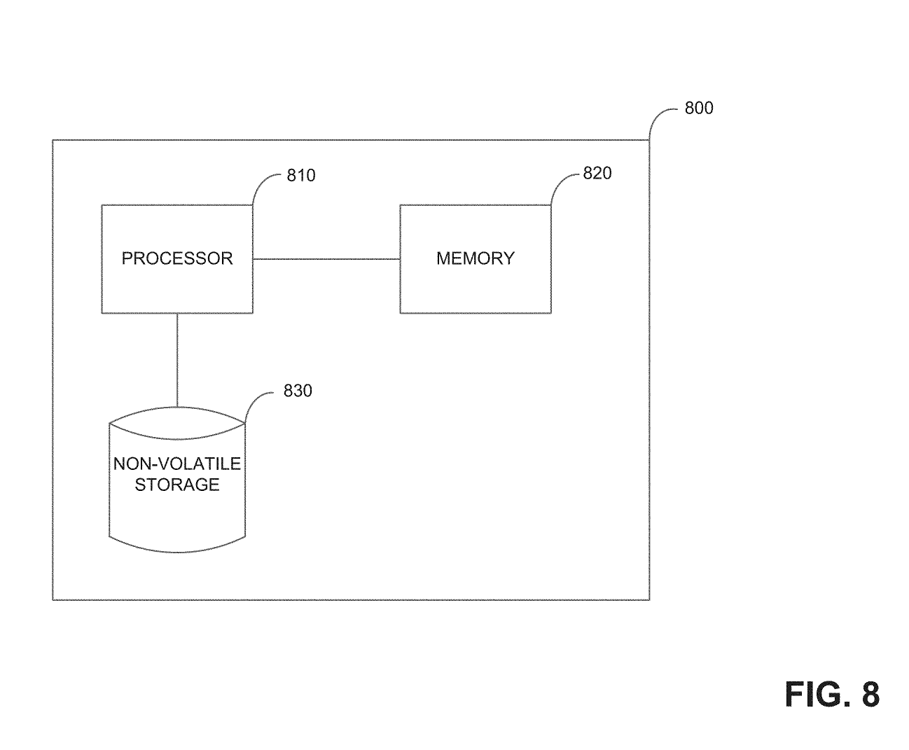

An illustrative implementation of a computer system 800 that may be used to control an additive fabrication device, such as additive fabrication device 700 shown in FIG. 7, is shown in FIG. 8. The computer system 800 may include one or more processors 810 and one or more non-transitory computer-readable storage media (e.g., memory 820 and one or more non-volatile storage media 830). The processor 810 may control writing data to and reading data from the memory 820 and the non-volatile storage device 830 in any suitable manner, as the aspects of the invention described herein are not limited in this respect. To perform functionality and/or techniques described herein, the processor 810 may execute one or more instructions stored in one or more computer-readable storage media (e.g., the memory 820, storage media, etc.), which may serve as non-transitory computer-readable storage media storing instructions for execution by the processor 810.

In connection with techniques described herein, code used to, for example, perform gamut mapping, calculate a mapping between optical absorption spectra and color stacks, determine optical absorption spectra from optical reflectance spectra, etc., may be stored on one or more computer-readable storage media of computer system 800. Processor 810 may execute any such code to provide any techniques for additive fabrication of color objects as described herein. Any other software, programs or instructions described herein may also be stored and executed by computer system 800. It will be appreciated that computer code may be applied to any aspects of methods and techniques described herein. For example, computer code may be applied to interact with an operating system to control an additive fabrication device.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of producing multicolor objects via additive fabrication by forming a plurality of layers on a substrate from a plurality of materials each having a respective color, the method comprising:
obtaining image data, the image data indicating a color for each of a plurality of positions;
determining a plurality of color stacks based on the image data, each color stack being determined based on the color associated with one of the plurality of positions of the image data, and each color stack specifying a sequence of materials, where each material in the sequence is selected from amongst the plurality of materials; and
forming, via additive fabrication, a plurality of layers from the plurality of materials according to the specified sequence of materials associated with each color stack.

2. The method of claim 1, wherein the image data represents a two-dimensional image and the plurality of color stacks are formed on a substantially flat substrate.

3. The method of claim 2, further comprising forming the substrate from a plurality of layers of a white material.

4. The method of claim 1, further comprising obtaining a model of a three-dimensional object having a surface, and wherein the image data indicates a color for each of a plurality of positions on the surface.

5. The method of claim 4, further comprising forming a bulk region of the three-dimensional object from a substrate material, and wherein at least portions of the plurality of layers formed from the plurality of materials according to the specified sequence of materials associated with each color stack are formed on the bulk region.

6. The method of claim 1, further comprising resampling a source image to produce the obtained image data.

7. The method of claim 1, wherein the plurality of materials exhibit at least three different colors.

8. The method of claim 7, wherein the at least three different colors include cyan, magenta and yellow.

9. The method of claim 1, wherein each of the plurality of materials is a transparent material.

10. The method of claim 9, wherein each of the plurality of materials comprises a photopolymer and one or more color pigments.

11. The method of claim 1, wherein forming the plurality of color stacks via additive fabrication comprises depositing a liquid photopolymer and curing the photopolymer to a solid material.

12. The method of claim 1, wherein each of the plurality of color stacks specifies a sequence of at least twenty instances of materials selected from amongst the plurality of materials.

13. The method of claim 1, wherein the sequence of materials specified by each color stack groups instances of the same material in contiguous blocks.

14. The method of claim 1, wherein the sequence of materials specified by each color stack includes instances of each material only in a prescribed order.

15. An additive fabrication device configured to produce multicolor objects by forming a plurality of layers on a substrate from a plurality of materials each having a respective color, the additive fabrication device comprising:
a build platform;
one or more printheads configured to deposit liquid droplets of one of the plurality of materials onto the build platform or onto previously formed solid material;
a source of actinic radiation configured to cure deposited liquid droplets to produce solid material;
at least one processor; and
at least one processor-readable medium comprising processor-executable instructions that, when executed, perform a method comprising:
obtaining image data, the image data indicating a color for each of a plurality of positions;
determining a plurality of color stacks based on the image data, each color stack being determined based on the color associated with one of the plurality of positions of the image data, and each color stack specifying a sequence of materials, where each material in the sequence is selected from amongst the plurality of materials; and
operating the one or more printheads to form a plurality of layers from the plurality of materials according to the specified sequence of materials associated with each color stack.

16. The additive fabrication device of claim 15, wherein the image data represents a two-dimensional image and the plurality of color stacks are formed by the one or more printheads on a substantially flat substrate.

17. The additive fabrication device of claim 16, wherein the method further comprises forming the substrate from a plurality of layers of a white material.

18. The additive fabrication device of claim 15, wherein the method further comprises obtaining a model of a three-dimensional object having a surface, and wherein the image data indicates a color for each of a plurality of positions on the surface.

19. The additive fabrication device of claim 18, wherein the method further comprises forming a bulk region of the three-dimensional object from a substrate material, and wherein at least portions of the plurality of layers formed from the plurality of materials according to the specified sequence of materials associated with each color stack are formed on the bulk region.

20. The additive fabrication device of claim 15, wherein the plurality of materials exhibit at least three different colors.

21. The additive fabrication device of claim 20, wherein the at least three different colors include cyan, magenta and yellow.

22. The additive fabrication device of claim 15, wherein each of the plurality of materials is a transparent material.

23. The additive fabrication device of claim 15, wherein each of the plurality of materials comprises a photopolymer and one or more color pigments.

24. A method of calibrating an additive fabrication device configured to fabricate multicolor objects by forming a plurality of layers on a substrate from a plurality of materials each having a respective color, the method comprising:
forming, using the additive fabrication device, a plurality of calibration patches having different colors, wherein each calibration patch is formed from a plurality of layers that are each formed from one of the plurality of materials, each calibration patch being associated with a layer specification;
measuring an optical reflectance of each of the plurality of calibration patches at a plurality of different wavelengths of light; and
determining a mapping between spectral absorption and the layer specifications of the calibration patches based at least in part on the measured optical reflectance of each of the plurality of calibration patches.

25. The method of claim 24, further comprising determining spectral absorption of each of the plurality of calibration patches at a plurality of different wavelengths of light based on the measured optical reflectances, and wherein determining the mapping is based on the spectral absorption of each of the plurality of calibration patches.

26. The method of claim 24, wherein forming the plurality of calibration patches comprises forming at least fifty calibration patches having different colors.

27. The method of claim 24, wherein the plurality of materials exhibit at least three different colors.

28. The method of claim 27, wherein the at least three different colors include cyan, magenta and yellow.

29. The method of claim 24, wherein each of the plurality of materials is a transparent material.

30. The method of claim 29, wherein each of the plurality of materials comprises a photopolymer and one or more color pigments.

31. The method of claim 24, wherein each calibration patch is formed from at least twenty layers.

32. The method of claim 24, further comprising obtaining data indicative of a color and determining a sequence of the plurality of materials based on the color and the determined mapping.
